(19) United States
(12) Patent Application Publication
(10) Pub. No.: US 2009/0196356 A1
(43) Pub. Date: Aug. 6, 2009

(54) MULTI-STREAM DECODER APPARATUS

(76) Inventor: Mitsunori Houki, Kyoto (JP)

Correspondence Address: MCDERMOTT WILL & EMERY LLP, 600 13TH STREET, NW, WASHINGTON, DC, 20005-3096, US

(21) Appl. No.: 12/067,001

(22) PCT Filed: May 23, 2006
(86) PCT No.: PCT/JP2006/310224

§ 371 Date: Mar. 14, 2008

(30) Foreign Application Priority Data
Sep. 14, 2005 (JP) 2005-266969

(51) Int. Cl. H04N 7/26; H04L 27/00

(52) U.S. Cl. 375/240.25; 375/316; 375/E07.027

(57) ABSTRACT

A time management section (102) and a bitstream switching control section (103) are provided in a decoder control device (100), and at the end of a predetermined unit of decoding process, a decoder (110) notifies the switching control section (103) of the completion of the decoding process. The time management section (102) sets the limit time that is allowed for decoding each bitstream within the prescribed time based on the decoder capacity, the information on the number of bitstreams to be decoded, the image size information and the frame rate extracted from the bitstream. If the limit time is reached, the switching control section (103) is instructed to switch bitstreams from one to another. The switching control section (103) switches bitstreams from one to another, by receiving the switching instruction from the time management section (102) and the completion notification from the decoder (110) notifying the completion of the predetermined unit of decoding process.

### TECHNICAL FIELD

The present invention relates to a multi-stream decoder apparatus for assisting in a process of decoding a plurality of encoded bitstreams.

### BACKGROUND ART

FIG. 18 shows a configuration of a conventional multi-stream decoder apparatus. Herein, MPEG2 Video is used as an example.

The multi-stream decoder apparatus of FIG. 18 includes first and second stream buffers (SB) 1021 and 1022 being storage devices for storing a plurality of bitstreams, a first switching device (SW) 1020 for switching between the outputs from these stream buffers 1021 and 1022, a decoder 1010, first and second frame memories (FM) 1031 and 1032 for storing decoded data, a second switching device (SW) 1030 for switching between these frame memories 1031 and 1032 depending on the input bitstream, and a decoder control device 1000. The decoder control device 1000 includes a switching control section 1001, and the decoder 1010 includes a variable-length decoding section 1011, a dequantization section 1012, an inverse DCT section 1013 and a motion compensation section 1014.

The switching control section 1001 in the decoder control device 1000 switches, picture by picture, the first switching device 1020 via a signal line 1050 and the second switching device 1030 via a signal line 1051.

The bitstreams stored in the first stream buffer 1021 and the second stream buffer 1022 are output via a signal line 1060 and a signal line 1061, and one of them is selected by the first switching device 1020 and input to the decoder 1010 via a signal line 1062. The bitstream input to the decoder 1010 is decoded in variable-length decoding through the variable-length decoding section 1011, dequantized through the dequantization section 1012, and inverse-DCTed through the inverse DCT section 1013. One of an I/O bus 1072 from the first frame memory 1031 and an I/O bus 1073 from the second frame memory 1032 is selected by the second switching device 1030. The motion compensation section 1014 adds together a reference image obtained from the frame memory selected by the second switching device 1030 via a signal line 1071 and the result of the inverse DCT thorough the inverse DCT section 1013 to produce a restored image, and the restored image is stored in a frame memory selected by the second switching device 1030 via a signal line 1070.

Thus, with the conventional configuration, a plurality of bitstreams are decoded by a single decoder 1010 while switching between the bitstreams, wherein the switching occurs only by the unit of processing of the input bitstreams (e.g., by pictures) (see Patent Document 1).

Patent Document 1: Japanese Laid-Open Patent Publication No. 2002-112195

### DISCLOSURE OF THE INVENTION

### Problems to be Solved by the Invention

With the conventional configuration, however, the bitstreams to be decoded are switched therebetween only by the unit of processing of the input bitstreams, whereby if one bitstream underflows to delay the decoding process, for example, the process of decoding the other bitstream will also be delayed. Particularly, when decoding a plurality of independent bitstreams while switching from one to another, the system itself may fail.

Moreover, with the conventional configuration, when bitstreams are switched from one to another, it is not possible to know the amount of bitstream that is remaining un-decoded in the decoder. Therefore, it is necessary to rewind the bitstream more than necessary when switching from one bitstream to another, thus increasing the switching overhead.

Moreover, with the conventional configuration, there is provided a decoder which as it is can decode a plurality of bitstreams. Therefore, even when decoding a single bitstream, it consumes the same peak memory bandwidth and the same amount of power as those consumed when decoding multiple bitstreams.

The present invention has been made to solve problems as set forth above, and has an object to provide a decoder apparatus capable of decoding a plurality of bitstreams while suppressing the influence between bitstreams, suppressing the overhead when switching from one bitstream to another, and further suppressing the peak memory bandwidth and the power consumption.

### Means for Solving the Problems

A first multi-stream decoder apparatus of the present invention is a multi-stream decoder apparatus, including storage devices each storing one of a plurality of bitstreams, a first switching device for switching between outputs from the storage devices, a decoder for receiving and decoding an output from the first switching device, a plurality of frame memories for storing data decoded by the decoder, a second switching device for switching between the frame memories depending on the bitstream, and a decoder control means for controlling the decoder, wherein: the decoder control means includes: header analysis means for analyzing a header in the bitstream; time management means for allotting a process time to each bitstream; and switching control means for controlling the first and second switching devices; the time management means determines a limit time that is allowed for decoding each bitstream within a prescribed time based on bitstream information including an image size and a frame rate obtained by the header analysis means, a processing capacity of the decoder, and information including the number of bitstreams to be decoded, and outputs a bitstream switching instruction signal when the decoding process reaches the limit time; and the switching control means switches the first and second switching devices based on the bitstream switching instruction signal output from the time management means, and a completion notification signal, which is output when the decoder completes decoding of a first predetermined unit of each bitstream.

A second multi-stream decoder apparatus of the present invention is the first multi-stream decoder apparatus, wherein the time management means re-sets the limit time that is allowed for decoding each bitstream for each prescribed time.

A third multi-stream decoder apparatus of the present invention is the first multi-stream decoder apparatus, wherein the time management means instructs the decoder to discontinue the decoding process when bitstream decoding process time reaches the limit time, and the decoder immediately discontinues the decoding process upon receiving the discontinuation instruction.

A fourth multi-stream decoder apparatus of the present invention is the third multi-stream decoder apparatus, wherein when decoding is discontinued, the decoder control means retracts information in the decoder that is necessary for resuming the discontinued decoding process, and resumes the decoding process by re-setting the retracted information in the decoder before the discontinued bitstream decoding process is next started.

A fifth multi-stream decoder apparatus of the present invention is the fourth multi-stream decoder apparatus, wherein decoding processes of a plurality of bitstreams are discontinued within the prescribed time and if decoding of the first predetermined unit of a bitstream other than the discontinued bitstreams is completed early to leave spare process time within the prescribed time, the limit time that is allowed for decoding each discontinued bitstream is re-set based on an estimated time required for completing decoding of the first predetermined unit of the bitstream.

A sixth multi-stream decoder apparatus of the present invention is the fourth multi-stream decoder apparatus, wherein: the apparatus includes a first counter in the decoder for counting an amount of bits processed starting from a beginning of a second predetermined unit, and rewind control means in the decoder control means for rewinding a pointer of the storage device; and when the decoder control means resumes the decoding process on a bitstream of which the decoding process has been discontinued by the time management means, the rewind control means rewinds the pointer of the storage device back to a beginning of the second predetermined unit based on information of the first counter so that the decoding process is resumed starting from the beginning of the second predetermined unit.

A seventh multi-stream decoder apparatus of the present invention is the fourth multi-stream decoder apparatus, wherein: the apparatus further includes an output control device for receiving outputs from the plurality of frame memories to output an image, and buffer management means in the decoder control means for managing an amount of data of the plurality of frame memories; and based on an amount of data supplied to the plurality of frame memories, which is notified from the decoder and an amount of data consumed by the plurality of frame memories, which is notified from the output control device, the buffer management means instructs the decoder to discontinue the decoding process, and the decoder immediately discontinues the decoding process upon receiving the discontinuation instruction.

An eighth multi-stream decoder apparatus of the present invention is the seventh multi-stream decoder apparatus, wherein based on an amount of data supplied to the plurality of frame memories, which is notified from the decoder and an amount of data consumed by the plurality of frame memories, which is notified from the output control device, the buffer management means instructs the output control device to switch output images from one to another, and the output control device immediately switches the output images from one to another upon receiving the switching instruction.

A ninth multi-stream decoder apparatus of the present invention is the first multi-stream decoder apparatus, wherein: the apparatus includes in the decoder an input buffer for temporarily holding an output from the first switching device and a second counter for monitoring an amount of unprocessed bits in the input buffer, and includes in the decoder control means rewind control means for rewinding a pointer of the storage device; the decoder control means retracts information of the second counter when the switching control means switches the first switching device; and when resuming the decoding process on the bitstream, which was being processed before the switching, the rewind control means rewinds the pointer of the storage device to a position up to which the decoder has actually consumed the bitstream based on the information of the second counter.

A tenth multi-stream decoder apparatus of the present invention is the ninth multi-stream decoder apparatus, further including means for preventing the bitstream in the storage device from being overwritten based on information on the pointer of the storage device.

An eleventh multi-stream decoder apparatus of the present invention is the first multi-stream decoder apparatus, wherein the decoder control means judges, for each prescribed time, a type of the bitstream, which was being decoded by the decoder until immediately before an end of the prescribed time, to determine an order in which bitstreams are decoded in the next prescribed time.

A twelfth multi-stream decoder apparatus of the present invention is the first multi-stream decoder apparatus, wherein: the apparatus includes in the decoder a memory access control device for controlling a frequency of access to the plurality of frame memories; and the memory access control device controls the frequency of access to the plurality of frame memories based on bitstream information including an image size and a frame rate obtained by the header analysis means and information including the number of bitstreams to be decoded, which is notified from the decoder control means.

A thirteenth multi-stream decoder apparatus of the present invention is the first multi-stream decoder apparatus, further including a clock control device for determining a frequency of a clock supplied to the decoder based on bitstream information including an image size and a frame rate obtained by the header analysis means, a processing capacity of the decoder, and information including the number of bitstreams to be decoded, which is notified from the decoding control means.

A fourteenth multi-stream decoder apparatus of the present invention is the first multi-stream decoder apparatus, further including a clock control device for selectively supplying or stopping a clock to the decoder based on information on the prescribed time notified from the decoder control means and completion notification from the decoder notifying completion of the first predetermined unit of decoding process.

A fifteenth multi-stream decoder apparatus of the present invention is the first multi-stream decoder apparatus, wherein the first predetermined unit is pictures, slices, macroblock lines, or macroblocks.

A sixteenth multi-stream decoder apparatus of the present invention is the first multi-stream decoder apparatus, wherein the prescribed time is a picture time, a slice time, a macroblock line time or a macroblock time averagely allotted based on a frame rate in the bitstream.

A seventeenth multi-stream decoder apparatus of the present invention is the sixth multi-stream decoder apparatus, wherein the second predetermined unit is pictures, slices, macroblock lines, or macroblocks.

An eighteenth multi-stream decoder apparatus of the present invention is the first multi-stream decoder apparatus, wherein the bitstream is a bitstream compressed in MPEG1, MPEG2, MPEG4, or H.264.

### Effects of the Invention

With the first multi-stream decoder apparatus of the present invention, it is possible to decode multiple bitstreams while maximally utilizing the capacity of the decoder apparatus and preventing the influence between bitstreams.

With the second multi-stream decoder apparatus of the present invention, since the limit time to be allotted for decoding each bitstream can be set for each prescribed time, it is possible to allot an optimal process time based on the status of the decoding process of the bitstream.

With the third multi-stream decoder apparatus of the present invention, since the decoding process can be discontinued immediately when the decoding limit time is reached, decoding processes of bitstreams other than the bitstream of which the decoding process is discontinued are not influenced.

With the fourth multi-stream decoder apparatus of the present invention, since the decoding process of a bitstream of which the decoding process has been discontinued can be resumed, the discontinued bitstream can be decoded without being interrupted.

With the fifth multi-stream decoder apparatus of the present invention, the spare time within the prescribed time is re-allotted to a bitstream of which the decoding process has been discontinued, whereby it is possible to decode multiple bitstreams while maximally utilizing the capacity of the decoder apparatus.

With the sixth multi-stream decoder apparatus of the present invention, the decoding process can be resumed from the beginning of a second predetermined unit, e.g., a picture, a slice, a macroblock line or a macroblock, for example, whereby the decoding process can be resumed by retracting only the information of a higher hierarchical level than the second predetermined unit when the decoding process is discontinued.

With the seventh multi-stream decoder apparatus of the present invention, the decoding process can be performed while monitoring the data consumption by the output control device. Therefore, it is possible to continue the decoding process until the last moment before the output control device completely consumes data.

With the eighth multi-stream decoder apparatus of the present invention, since the output images can be switched from one to another depending on the amount of data supplied from the decoder apparatus and the amount of data consumed by the output control device, it is possible to output an image that does not give awkwardness even if the decoding process discontinues.

With the ninth multi-stream decoder apparatus of the present invention, it is possible to eliminate the overhead of rewinding the bitstream when switching bitstreams from one to another.

With the tenth multi-stream decoder apparatus of the present invention, it is possible to prevent an internal unprocessed bitstream from being overwritten.

With the eleventh multi-stream decoder apparatus of the present invention, it is possible to reduce the overhead due to bitstream switching.

With the twelfth multi-stream decoder apparatus of the present invention, the memory bandwidth can be suppressed to the peak bandwidth according to the bitstream to be decoded, whereby it is possible to give some memory bandwidth to other applications in a system where external memory is shared.

With the thirteenth multi-stream decoder apparatus of the present invention, the clock frequency can be set to a value according to the bitstream to be decoded, whereby it is possible to suppress the power consumption.

With the fourteenth multi-stream decoder apparatus of the present invention, where decoding of a plurality of bitstreams is completed before the end of the prescribed time, the clock can be stopped, thus suppressing the power consumption.

With the fifteenth multi-stream decoder apparatus of the present invention, it is possible to decode multiple bitstreams while maximally utilizing the capacity of the decoder apparatus and preventing the influence between bitstreams.

With the sixteenth multi-stream decoder apparatus of the present invention, it is possible to decode multiple bitstreams while maximally utilizing the capacity of the decoder apparatus and preventing the influence between bitstreams.

With the seventeenth multi-stream decoder apparatus of the present invention, the decoding process can be resumed from the beginning of a second predetermined unit, e.g., a picture, a slice, a macroblock line or a macroblock, for example, whereby the decoding process can be resumed by retracting only the information of a higher hierarchical level than the second predetermined unit when the decoding process is discontinued.

With the eighteenth multi-stream decoder apparatus of the present invention, it is possible to decode multiple bitstreams while maximally utilizing the capacity of the decoder apparatus and preventing the influence between bitstreams.

### BRIEF DESCRIPTION OF THE DRAWINGS

FIG. 1 is a diagram showing a general configuration of a multi-stream decoder apparatus according to first, second and seventh embodiments.

FIG. 2 is a timing diagram showing an operation of the multi-stream decoder apparatus according to the first embodiment.

FIG. 3 is a timing diagram showing an operation of the multi-stream decoder apparatus according to the second embodiment.

FIG. 4 is a diagram showing a general configuration of a multi-stream decoder apparatus according to a third embodiment.

FIG. 5 is a diagram showing an operation of a multi-stream decoder apparatus according to the third embodiment.

FIG. 6 is a diagram showing a general configuration of a multi-stream decoder apparatus according to a fourth embodiment.

FIG. 7 is a timing diagram showing an operation of the multi-stream decoder apparatus according to the fourth embodiment.

FIG. 8 is a diagram showing a general configuration of a multi-stream decoder apparatus according to a fifth embodiment.

FIG. 9 is a diagram showing an operation of the multi-stream decoder apparatus according to the fifth embodiment.

FIG. 10 is a diagram showing a general configuration of a multi-stream decoder apparatus according to a sixth embodiment.

FIG. 11 is a timing diagram showing an operation of the multi-stream decoder apparatus according to the seventh embodiment.

FIG. 12 is a diagram showing a general configuration of a multi-stream decoder apparatus according to an eighth embodiment.

FIG. 13 is a timing diagram showing an operation of the multi-stream decoder apparatus according to the eighth embodiment.

FIG. 14 is a diagram showing a general configuration of a multi-stream decoder apparatus according to a ninth embodiment.

FIG. 15 is a diagram showing an operation of the multi-stream decoder apparatus according to the ninth embodiment.

FIG. 16 is a diagram showing a general configuration of a multi-stream decoder apparatus according to a tenth embodiment.

FIG. 17 is a timing diagram showing an operation of the multi-stream decoder apparatus according to the tenth embodiment.

FIG. 18 is a diagram showing a general configuration of a conventional multi-stream decoder apparatus.

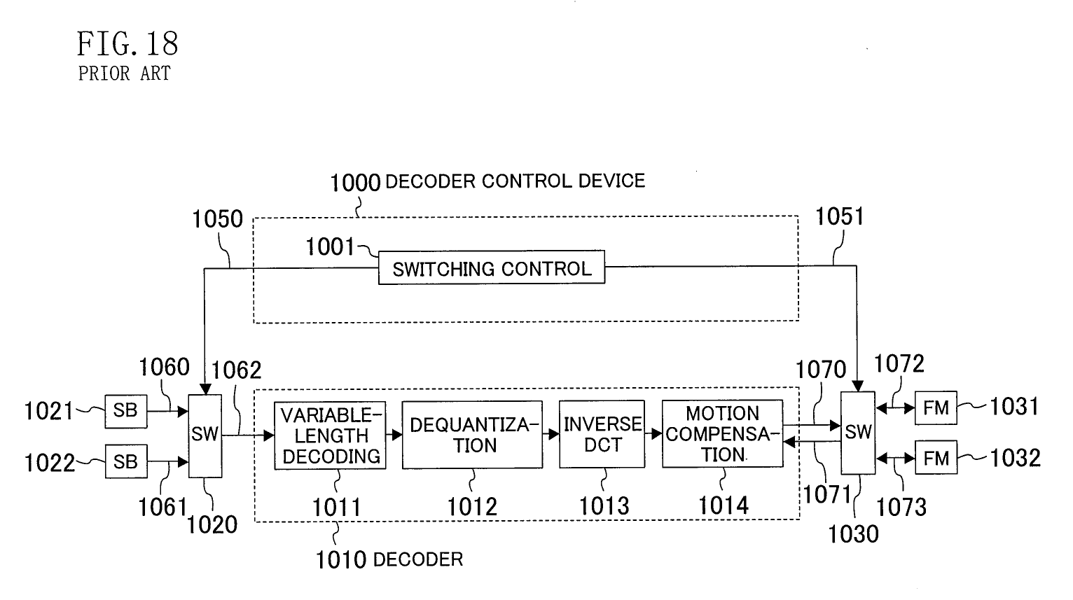

### DESCRIPTION OF REFERENCE NUMERALS

100 Decoder control device

101 Header analysis section

102 Time management section

103 Switching control section

110 Decoder

111 Variable-length decoding section

112 Dequantization section

113 Inverse DCT section

114 Motion compensation section

120, 130 Switching device (SW)

121,122 Stream buffer (SB)

131,132 Frame memory (FM)

300 Bit counter

310 Rewind control section

400 Buffer management section

410 Output control device

500 Unprocessed bit counter

510 Input buffer (IB)

650 Memory access control section

700, 750 Clock control section

### BEST MODE FOR CARRYING OUT THE INVENTION

Embodiments of the present invention will now be described with reference to the drawings. Throughout the various figures, like elements are denoted by like reference numerals and will not be described repeatedly.

For the sake of simplicity, the following embodiments will be directed to an operation of decoding two MPEG2 Video MP@HL bitstreams, wherein the prescribed time is one frame time ( 1/30 sec), a predetermined unit of decoder processing by which the completion of the process is notified is pictures, and the frame structure is employed for the picture structure of each bitstream.

For the sake of simplicity, in the following embodiments, the two bitstreams are referred to as “ch0” and “ch1”.

While the number of bitstreams decoded is two in the following embodiments, the number of bitstreams is not limited to this.

While the prescribed time is one frame time in the following embodiments, the prescribed time is not limited to this. While the predetermined unit by which the completion is notified is pictures, the predetermined unit is not limited to this. Moreover, while the frame structure is employed for the picture structure of each bitstream, the picture structure is not limited to this.

While two MPEG2 Video MP@HL streams are used as the combination of bitstreams, the bitstream combination may be one MPEG2 Video MP@HL stream and one MPEG2 Video MP@ML stream, or the like, and is not limited to this. While MPEG2 Video is used as an example as the bitstream compression scheme, the compression scheme is not limited to this, and other compression schemes such as H.264 may be used.

While the decoder section employs a configuration that assumes an MPEG2 decoding process, the decoder section may employ any configuration as long as it is suitable for the compression scheme used, and the configuration is not limited to those shown in the following embodiments. Moreover, although the term “decoder control device” is used herein, it may be either a hardware or software implementation.

### FIRST EMBODIMENT

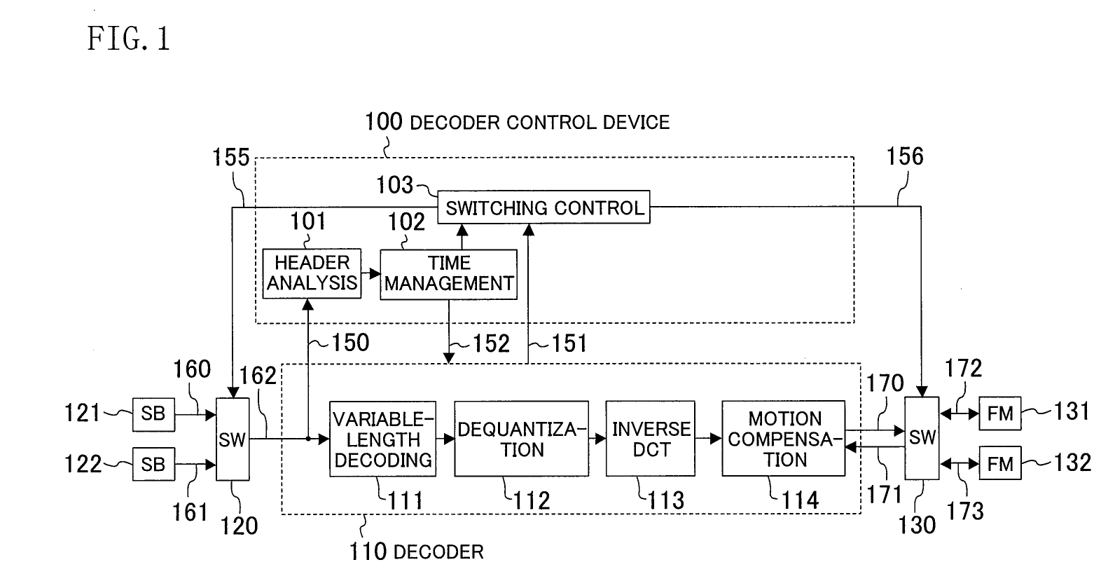

FIG. 1 shows a configuration of a multi-stream decoder apparatus according to a first embodiment. The multi-stream decoder apparatus of FIG. 1 includes first and second stream buffers (SB) 121 and 122 being storage devices for storing a plurality of bitstreams, a first switching device (SW) 120 for switching between the outputs from these stream buffers 121 and 122, a decoder 110, first and second frame memories (FM) 131 and 132 for storing decoded data, a second switching device (SW) 130 for switching between these frame memories 131 and 132 based on the input bitstream, and a decoder control device 100. The decoder control device 100 includes a header analysis section 101, a time management section 102, and a switching control section 103, and the decoder 110 includes a variable-length decoding section 111, a dequantization section 112, an inverse DCT section 113, and a motion compensation section 114. The first switching device 120 and the second switching device 130 are switched by control signals 155 and 156, respectively, from the switching control section 103 in the decoder control device 100.

The bitstreams stored in the first stream buffer 121 and the second stream buffer 122 are output via a signal line 160 and a signal line 161, and one of them is selected by the first switching device 120 and input to the decoder 110 via a signal line 162. The bitstream input to the decoder 110 is decoded in variable-length decoding through the variable-length decoding section 111, dequantized through the dequantization section 112, and inverse-DCTed through the inverse DCT section 113. One of an I/O bus 172 from the first frame memory 131 and an I/O bus 173 from the second frame memory 132 is selected by the second switching device 130. The motion compensation section 114 adds together a reference image obtained from the frame memory selected by the second switching device 130 via a signal line 171 and the result of the inverse DCT thorough the inverse DCT section 113 to produce a restored image, and the restored image is stored in a frame memory selected by the second switching device 130 via a signal line 170.

In the process of decoding each bitstream, each time a predetermined unit of decoding process (which is one picture in the description of the first embodiment) is completed, the decoder 110 notifies the switching control section 103 of the completion of the decoding process via a signal line 151.

It is assumed in the following description that the first stream buffer 121 and the first frame memory 131 are for ch0, and the second stream buffer 122 and the second frame memory 132 are for ch1.

As described above, the decoder control device 100 includes the header analysis section 101, the time management section 102 and the switching control section 103.

The header analysis section 101 obtains a bitstream via a signal line 150 or obtains a bitstream directly from the first stream buffer 121 and the second stream buffer 122, and analyzes the bitstream of a hierarchical layer that is higher than the slice layer (the picture layer or higher: although it is herein determined to be the picture layer or higher since the predetermined unit is pictures in the first embodiment, the hierarchical level varies depending on the predetermined unit). The frame rate and the image size information obtained by the header analysis section 101 are sent to the time management section 102.

The time management section 102 determines the decoding limit time for each bitstream based on the frame rate and the image size of the bitstream sent from the header analysis section 101 and the information on the capacity of the decoder 110.

When the decoding process of a bitstream reaches the limit time, the time management section 102 instructs the decoder 110 via a signal line 152 to discontinue the decoding process, and instructs the switching control section 103 to switch bitstreams to be decoded from one to another. When instructed by the time management section 102 to discontinue the decoding process, the decoder 110 immediately discontinues the decoding process.

The switching control section 103 switches bitstreams to be decoded from one to another upon receiving a bitstream switching instruction from the time management section 102 or a notification 151 from the decoder 110 notifying completion of the bitstream decoding process. Specifically, the switching control section 103 switches the first switching device 120 via the control signal 155 and switches the second switching device 130 via the control signal 156.

The method for determining the decoding limit time in the time management section 102 will now be described by way of an example. For the sake of simplicity, the following assumptions are made herein.

The prescribed time T is 1/30 sec (one frame time), and the decoder 110 is assumed to be capable of decoding one picture of the ch0 bitstream (MPEG2 Video MP@HL) in a0×T and one picture of the ch1 bitstream (MPEG2 Video MP@HL) in b0×T. The spare time that is left of the prescribed time as determined by the capacity estimation is denoted as ΔT0, and the limit time is denoted as T(limit).

Then, ΔT0 is expressed as follows:

$$\begin{matrix}Δ T 0 = Prescribed period - \\ ( \begin{matrix}Estimated time for decoding ch 0 + \\ Estimated time for decoding ch 1\end{matrix} ) \\ = T - ( a 0 \times T + b 0 \times T ) \\ = ( 1 - a 0 - b 0 ) T\end{matrix} \qquad Expression ( 1 )$$

The limit time is determined as follows for a process of decoding the ch0 bitstream within the prescribed time T. For the sake of simplicity, it is assumed that the decoding process is performed starting from ch0, the order in which bitstreams are decoded is not limited to a particular order.

T(limit) is determined as follows:

$$\begin{matrix}\begin{matrix}T ( limit ch 0 ) = Estimated time for decoding ch 0 + \\ α 0 \times Δ T 0 \\ = a 0 \times T + α 0 \times ( 1 - a 0 - b 0 ) T\end{matrix} & Expression ( 2 ) \\ \begin{matrix}T ( limit ch 1 ) = Estimated time for decoding ch 0 + \\ Estimated time for decoding ch 1 + \\ β 0 \times Δ T 0 \\ = a 0 \times T + b 0 \times T + β 0 \times ( 1 - a 0 - b 0 ) T\end{matrix} & Expression ( 3 ) \\ 0 \leq T ( limit ch 0 ) , T ( limit ch 1 ) \leq T & Expression ( 4 )\end{matrix}$$

wherein α0 and β0 are coefficients.

There are no particular restrictions on the coefficients α0 and β0 as long as they satisfy Expression (4). Based on the values of α0 and β0, it is possible to prioritize the decoding processes of different bitstreams over one another. Even where the decoder is not capable of decoding two streams, it is possible to guarantee the complete decoding of one stream by providing the limit time within the prescribed time.

While an example of a method for calculating the limit time is shown above, it is not necessary to use the above calculation method.

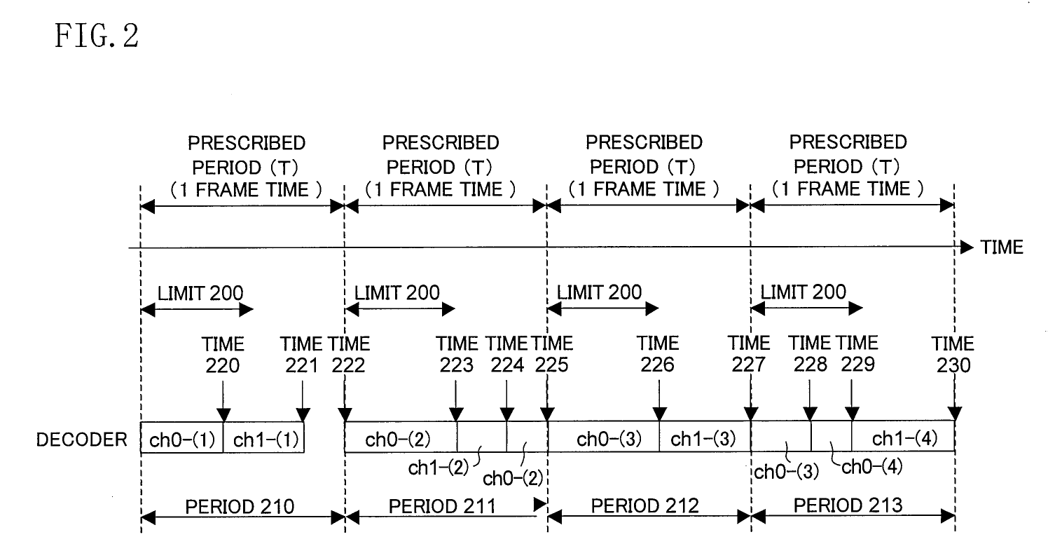

Next, an operation of a multi-stream decoder apparatus of the first embodiment will be described with reference to FIG. 2. Limit 200 in FIG. 2 denotes the limit time that is allowed for decoding the ch0 bitstream, and time 220 to 230 each denote a point in time at which bitstreams are switched from one to another or a predetermined unit of decoding process is completed. The designations (1), (2), (3) and (4) in the decoder section are the picture numbers assigned to pictures of each bitstream in the order they are decoded. For the sake of simplicity, the limit time allowed for decoding ch1 is the end of the prescribed period, which is not designated in the figure. While limit 200 takes the same value in all prescribed periods in the following description, the limit can be re-set for every prescribed period and the value thereof may vary.

A typical pattern of switching bitstreams from one to another by the decoder control device 100 will be described below.

Period 210 shows an operation where the decoding of the ch0 bitstream is completed within the limit time.

First, at time 220 when the decoding of one picture of the ch0 bitstream is completed, the decoder 110 sends a completion notification to the switching control section 103 in the decoder control device 100 via the signal line 151, and the switching control section 103 switches the bitstream to the ch1 bitstream. Then, at time 221 when the decoding of one picture of the ch1 bitstream is completed, the decoder 110 sends a completion notification to the switching control section 103 in the decoder control device 100 via the signal line 151, and the switching control section 103 switches the bitstream to the ch0 bitstream, thus completing the control in the prescribed period 210.

Period 211 shows an operation where the decoding of the ch0 bitstream is not completed within the limit time, thus resulting in discontinuation of the decoding process, after which the decoding process is resumed within the prescribed period.

First, at time 222, the decoding of the ch0 bitstream is started. Then, although the ch0 bitstream is decoded, the decoding of one picture is not completed at limit 200, which is the limit time for decoding ch0. Therefore, at time 223, the time management section 102 in the decoder control device 100 instructs the decoder 110 via the signal line 152 to discontinue the decoding process, and further instructs the switching control section 103 to switch bitstreams from one to another. Upon receiving the discontinuation instruction, the decoder 110 discontinues the decoding process, and the decoder control device 100 retracts information left in the decoder 110 that is necessary for resuming the decoding process. Upon receiving a bitstream switching instruction from the time management section 102, the switching device 103 switches the bitstream to the ch1 bitstream. Then, at time 224 when the decoding of one picture of the ch1 bitstream is completed, the decoder 110 sends a completion notification to the switching control section 103 in the decoder control device 100 via the signal line 151. Since the prescribed time has not elapsed at time 224, the information necessary for resuming the decoding of the ch0 bitstream that was retracted at time 223 by the decoder control section 100 is set in the decoder 110, and the decoder 110 resumes the decoding of the ch0 bitstream. Then, at time 225 when the decoding of one picture of the ch0 bitstream is completed, the decoder 110 sends a completion notification to the switching control section 103 in the decoder control device 100 via the signal line 151, thus completing the control in the prescribed period 211. While the discontinued bitstream decoding process is resumed at time 224, a different option may be available where the discontinued picture is discarded instead of resuming the decoding process.

Period 212 and period 213 show an operation where the decoding of the ch0 bitstream is not completed within the limit time, thus resulting in discontinuation of the decoding process, after which the decoding process is resumed over two prescribed periods.

First, at time 225, the decoding of the ch0 bitstream is started. Then, although the ch0 bitstream is decoded, the decoding of one picture is not completed at limit 200, which is the limit time for decoding ch0. Therefore, at time 226, the time management section 102 in the decoder control device 100 instructs the decoder 110 via the signal line 152 to discontinue the decoding process, and further instructs the switching control section 103 to switch bitstreams from one to another. Upon receiving the discontinuation instruction, the decoder 110 discontinues the decoding process, and the decoder control device 100 retracts information left in the decoder 110 that is necessary for resuming the decoding process. Upon receiving a bitstream switching instruction from the time management section 102, the switching device 103 switches the bitstream to the ch1 bitstream. Then, at time 227 when the decoding of one picture of the ch1 bitstream is completed, the decoder 110 sends a completion notification to the switching control section 103 in the decoder control device 100 via the signal line 151, and the switching control section 103 switches the bitstream to the ch0 bitstream, thus completing the control in the prescribed period 212. At time 227, the decoding of one picture of the ch0 bitstream for the preceding prescribed time has not been completed. Therefore, the information necessary for resuming the decoding of the ch0 bitstream that was retracted at time 226 by the decoder control section 100 is set in the decoder 110, and the decoder 110 resumes the decoding of the ch0 bitstream, which should have been decoded within the preceding prescribed time. At time 228 when the decoding of one picture of the ch0 bitstream, which should have been decoded within preceding prescribed time is completed, the limit time (limit 200) for decoding the ch0 bitstream in the current prescribed time has not been reached, whereby the next picture of the ch0 bitstream is successively decoded. At time 229 when the decoding of one picture of the ch0 bitstream is completed, the decoder 110 sends a completion notification to the switching control section 103 in the decoder control device 100 via the signal line 151, and the switching control section 103 switches the bitstream to the ch1 bitstream. Then, at time 230 when the decoding of one picture of the ch1 bitstream is completed, the decoder 110 sends a completion notification to the switching control section 103 in the decoder control device 100 via the signal line 151, and the switching control section 103 switches the bitstream to the ch0 bitstream, thus completing the control in the prescribed period 213. While the bitstrearn decoding process, which was discontinued in the previous prescribed time, is resumed at time 227, a different option may be available where the decoding process is started from the picture to be decoded in period 213, discarding the picture that should have been processed in the preceding prescribed time.

While three patterns of bitstream switching operations by the decoder control device 100 have been described above, it is understood that the discontinuation/resumption of the decoding process is not limited to the three patterns above, and there are various combinations of switching methods such as a combination of period 211 and period 212. While only the discontinuation and resumption of the decoding of the ch0 bitstream has been described herein, it is understood that there may occur discontinuation and resumption of the decoding of the ch1 bitstream.

Thus, according to the first embodiment, it is possible to decode multiple bitstreams while maximally utilizing the capacity of the decoder apparatus and preventing the bitstreams from influencing each other.

Moreover, since the limit time to be allotted for decoding each bitstream can be set for each prescribed time, it is possible to allot an optimal process time based on the status of the decoding process of the bitstream.

Since the decoding process can be discontinued immediately when the decoding limit time is reached, decoding processes of bitstreams other than the bitstream of which the decoding process is discontinued are not influenced.

Since the decoding process of a bitstream of which the decoding process has been discontinued can be resumed, the discontinued bitstream can be decoded without being interrupted.

### SECOND EMBODIMENT

In a second embodiment, a method for re-allotting the decoding limit time within the prescribed time by the time management section 102 will be described by way of an example. The apparatus configuration is as shown in FIG. 1. However, there are provided stream buffers and frame memories for three channels.

For the sake of simplicity, the following assumptions are made herein. The prescribed time T is 1/30 sec (one frame time), and the decoder 110 decodes the ch0 bitstream (MPEG2 Video MP@HL) for a1×T before discontinuing the decoding process, decodes the ch1 bitstream (MPEG2 Video MP@HL) for b1×T before discontinuing the decoding process, and decodes one picture of the ch2 bitstream (MPEG2 Video MP@HL) for c1×T to complete the process. Moreover, ch0 has X1 macroblocks of one picture undecoded when the decoding process is discontinued, and ch1 has Y1 macroblocks of one picture undecoded when the decoding process is discontinued. Moreover, the spare time that is left of the prescribed time upon completion of the decoding of the ch2 bitstream is denoted as T1, and the re-allotted limit time is denoted as T1(limit).

Then, T1 is expressed as follows:

$$\begin{matrix}T 1 = Prescribed time - \\ ( \begin{matrix}ch 0 decoding process time + \\ ch 1 decoding process time + \\ ch 2 decoding process time\end{matrix} ) \\ = T - ( a 1 \times T + b 1 \times T + c 1 \times T ) \\ = ( 1 - a 1 - b 1 - c 1 ) T\end{matrix} \qquad Expression ( 4 )$$

The limit time is re-set assuming that the decoding process is resumed starting from the ch0 bitstream within the spare time T1. T1 is expressed with start time 0 being the point in time at which decoding is resumed. While the decoding process is resumed starting from ch0 for the sake of simplicity, the order in which decoding processes of bitstreams are resumed is not limited to a particular order.

T1 (limit) is determined as follows.

$$\begin{matrix}T 1 ( limit ch 0 ) = ( X 1 / ( X 1 + Y 1 ) ) \times ( 1 - a 1 - b 1 - c 1 ) T & Expression ( 5 ) \\ \begin{matrix}T 1 ( limit ch 1 ) = T 1 \\ = ( 1 - a 1 - b 1 - c 1 ) T\end{matrix} & Expression ( 6 )\end{matrix}$$

While the description on the re-allotment of the limit time according to the capacity of the decoder 110 will not herein be provided for the sake of simplicity, the limit time can be re-allotted based on the remaining number of macroblocks as in the first embodiment while taking into consideration the capacity of the decoder 110.

While an example of the method for calculating the limit time after the re-allotment has been described above, it is not limited to the above calculated method.

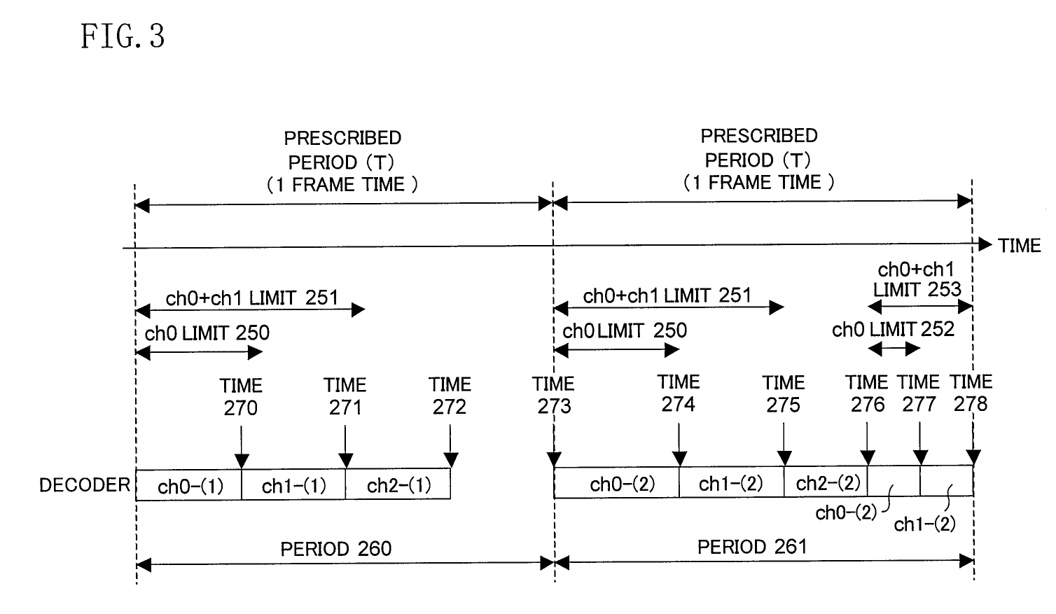

Next, an operation of a multi-stream decoder apparatus of the second embodiment will be described with reference to FIG. 3. Limit 250 in FIG. 3 denotes the limit time that is allowed for completing the decoding of the ch0 bitstream, limit 251 denotes the limit time that is allowed for completing the decoding of the ch0 and ch1 bitstreams, limit 252 denotes the limit time that is allowed for completing the decoding of the ch0 bitstream after the limit time re-allotment, limit 253 denotes the limit time that is allowed for completing the decoding of the ch0 and ch1 bitstreams after the limit time re-allotment, and time 270 to 278 each denote a point in time at which bitstreams are switched from one to another or a predetermined unit of decoding process is completed. The designations (1) and (2) in the decoder section are the picture numbers assigned to pictures of each bitstream in the order they are decoded. For the sake of simplicity, the limit time allowed for completing the decoding of ch2 is the end of the prescribed period, which is not designated in the figure. While limit 250 and limit 251 each take the same value in all prescribed periods in the following description, the limit can be re-set for every prescribed period and the value thereof may vary.

The operation of re-allotting the limit time by the decoder control device 100 will now be described.

Period 260 shows an operation where the decoding of the ch0 bitstream is completed within the limit time. This operation is the same as that described in the first embodiment, except for the number of bitstreams decoded.

First, at time 270 when the decoding of one picture of the ch0 bitstream is completed, the decoder 110 sends a completion notification to the switching control section 103 in the decoder control device 100 via the signal line 151, and the switching control section 103 switches the bitstream to the ch1 bitstream. Then, at time 271 when the decoding of one picture of the ch1 bitstream is completed, the decoder 110 sends a completion notification to the switching control section 103 in the decoder control device 100 via the signal line 151, and the switching control section 103 switches the bitstream to the ch2 bitstream. Then, at time 272 when the decoding of one picture of the ch2 bitstream is completed, the decoder 110 sends a completion notification to the switching control section 103 in the decoder control device 100 via the signal line 151, and the switching control section 103 switches the bitstream to the ch0 bitstream, thus completing the control in the prescribed period 260.

Period 261 shows an operation where the decoding of the ch0 bitstream and the decoding of the ch1 bitstream are not completed within the limit time, thus resulting in discontinuation of the decoding processes, after which the decoding limit time is re-allotted and the decoding processes are resumed within the prescribed period.

First, at time 273, the decoding of the ch0 bitstream is started. Then, although the ch0 bitstream is decoded, the decoding of one picture is not completed at limit 250, which is the limit time for decoding ch0. Therefore, at time 274, the time management section 102 in the decoder control device 100 instructs the decoder 110 via the signal line 152 to discontinue the decoding process, and further instructs the switching control section 103 to switch bitstreams from one to another. Upon receiving the discontinuation instruction, the decoder 110 discontinues the decoding process, and the decoder control device 100 retracts information left in the decoder 110 that is necessary for resuming the decoding process. Upon receiving a bitstream switching instruction from the time management section 102, the switching device 103 switches the bitstream to the ch1 bitstream. Then, although the ch1 bitstream is decoded, the decoding of one picture is not completed at limit 251, which is the limit time for decoding ch1. Therefore, at time 275, the time management section 102 in the decoder control device 100 instructs the decoder 110 via the signal line 152 to discontinue the decoding process, and further instructs the switching control section 103 to switch bitstreams from one to another. Upon receiving the discontinuation instruction, the decoder 110 discontinues the decoding process, and the decoder control device 100 retracts information left in the decoder 110 that is necessary for resuming the decoding process. Upon receiving a bitstream switching instruction from the time management section 102, the switching device 103 switches the bitstream to the ch2 bitstream. Then, at time 276 when the decoding of one picture of the ch2 bitstream is completed, the decoder 110 sends a completion notification to the switching control section 103 in the decoder control device 100 via the signal line 151. Since the prescribed time has not elapsed at time 276, the decoding limit time for ch0 and that for ch1 are re-allotted.

At time 276, the information necessary for resuming the decoding of the ch0 bitstream that was retracted at time 274 by the decoder control section 100 is set in the decoder 110, and the decoder 110 resumes the decoding of the ch0 bitstream. Then, at time 277 when the decoding of one picture of the ch0 bitstream is completed, the decoder 110 sends a completion notification to the switching control section 103 in the decoder control device 100 via the signal line 151, switching the bitstream to the ch1 bitstream. Then, at time 277, the information necessary for resuming the decoding of the ch1 bitstream that was retracted at time 275 by the decoder control section 100 is set in the decoder 110, and the decoder 110 resumes the decoding of the ch1 bitstream. Then, at time 278 when the decoding of one picture of the ch1 bitstream is completed, the decoder 110 sends a completion notification to the switching control section 103 in the decoder control device 100 via the signal line 151, and the switching control section 103 switches the bitstream to the ch0 bitstream, thus completing the control in the prescribed period 261. While the bitstream decoding process is resumed in the order of ch0 and then ch1, the order in which decoding processes of bitstreams are resumed is not limited to a particular order.

The operation after the limit time re-allotment is the same as the operation performed when the limit time is allotted at the beginning of the prescribed time (what is described above in the first embodiment), and therefore will not be described repeatedly.

Thus, according to the second embodiment, the spare time within the prescribed time is re-allotted to a bitstream of which the decoding process has been discontinued, whereby it is possible to decode multiple bitstreams while maximally utilizing the capacity of the decoder apparatus.

### THIRD EMBODIMENT

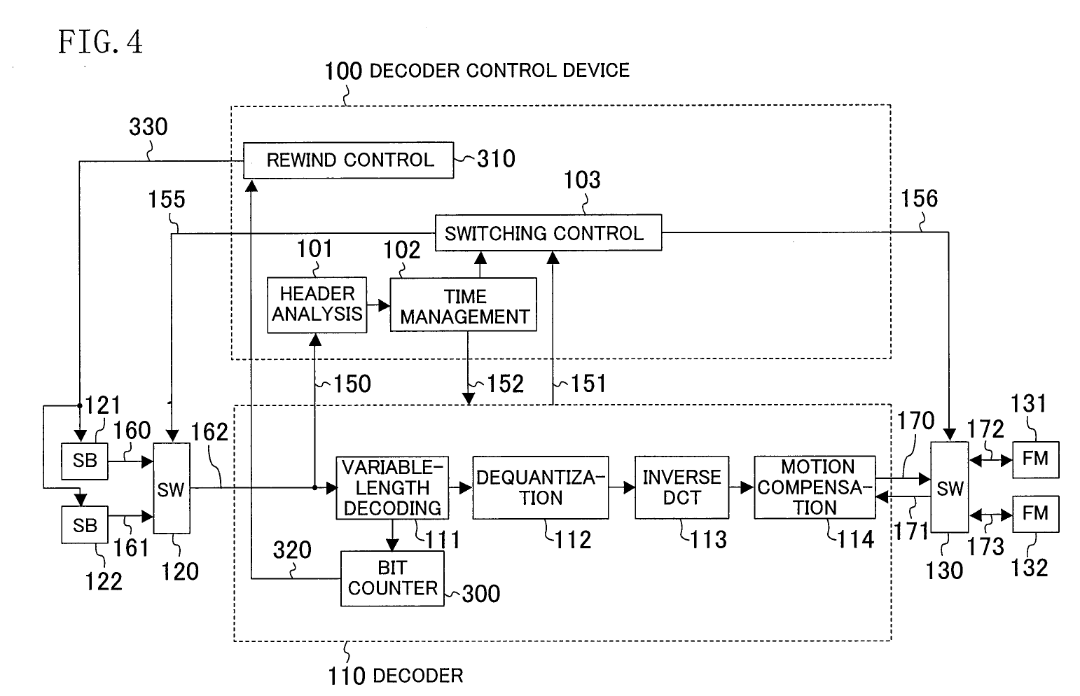

FIG. 4 shows a configuration of a multi-stream decoder apparatus according to a third embodiment. The multi-stream decoder apparatus of FIG. 4 includes the multi-stream decoder apparatus of the first embodiment, and further includes a bit counter 300 in the decoder 110, and a rewind control section 310 in the decoder control device 100.

The bit counter 300 is a counter for counting the amount of bits processed by the decoder 110 starting from the beginning of the bitstream hierarchical level (the picture layer, the slice layer, the macroblock layer, etc.).

The rewind control section 310 has a function of taking in the value of the bit counter 300 via a signal line 320, and rewinding the pointers of the first stream buffer 121 and the second stream buffer 122 for storing different bitstreams.

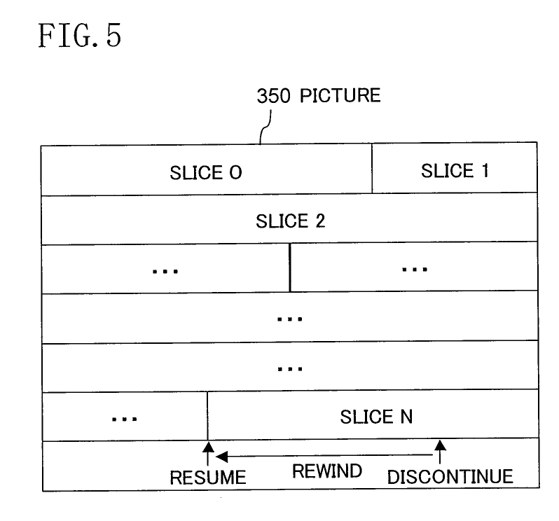

Next, an operation of the multi-stream decoder apparatus of the third embodiment will be described with reference to FIGS. 2 and 5. FIG. 5 shows a decoded frame, wherein picture 350 includes a plurality of slice layers (slice 0, slice 1, . . . , slice N, . . . ).

While the bit counter 300 is described as being a counter for counting the amount of bits starting from the beginning of the slice layer for the sake of simplicity, it is understood that it is not limited to a counter that counts from the beginning of the slice layer.

How the bit counter 300 and the rewind control section 310 are used for discontinuing and resuming the decoding process will now be described based on the operation of period 211 in FIG. 2.

First, at time 222, the decoding of the ch0 bitstream is started. Then, although the ch0 bitstream is decoded, the decoding of one picture is not completed at limit 200, which is the limit time for decoding ch0. Therefore, at time 223, the time management section 102 in the decoder control device 100 instructs the decoder 110 via the signal line 152 to discontinue the decoding process, and further instructs the switching control section 103 to switch bitstreams from one to another. It is assumed herein that discontinuation occurs at a point in slice N of FIG. 5. Upon receiving the discontinuation instruction, the decoder 110 discontinues the decoding process, and the decoder control device 100 retracts information left in the decoder 110 that is necessary for resuming the decoding process. In this process, the information of the bit counter 300 is also retracted. Upon receiving a bitstream switching instruction from the time management section 102, the switching device 103 switches the bitstream to the ch1 bitstream. Then, at time 224 when the decoding of one picture of the ch1 bitstream is completed, the decoder 110 sends a completion notification to the switching control section 103 in the decoder control device 100 via the signal line 151. Since the prescribed time has not elapsed at time 224, the information necessary for resuming the decoding of the ch0 bitstream that was retracted at time 223 by the decoder control section 100 is set in the decoder 110, and then the rewind control section 310 rewinds the pointer of the first stream buffer 121, being the bitstream storage device on the ch0 side, to the beginning of slice N based on the information of the bit counter300. Then, the decoder 110 resumes the decoding of the ch0 bitstream starting from the beginning of slice N. Then, at time 225 when the decoding of one picture of the ch0 bitstream is completed, the decoder 110 sends a completion notification to the switching control section 103 in the decoder control device 100 via the signal line 151, thus completing the control in the prescribed period 211.

While how the bit counter 300 and the rewind control section 310 are used has been described with respect to an example where the decoding process is discontinued and resumed after reaching the decoding limit time, it is understood that they can be used when discontinuing and resuming the decoding process where the limit time is not reached.

Thus, according to the third embodiment, the decoding process can be resumed from the beginning of a picture, a slice, a macroblock line or a macroblock, for example, whereby the decoding process can be resumed by retracting only the information of a higher hierarchical level than the bitstream hierarchical level on which the bit counter 300 is counting when the decoding process is discontinued.

### FOURTH EMBODIMENT

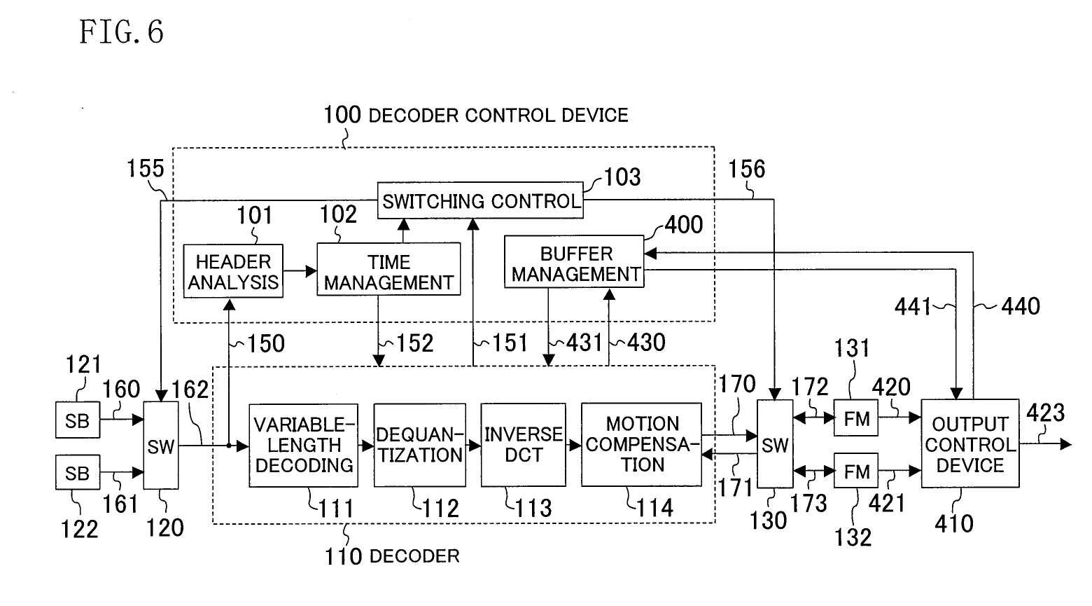

FIG. 6 shows a configuration of a multi-stream decoder apparatus according to a fourth embodiment. The multi-stream decoder apparatus of FIG. 6 includes the multi-stream decoder apparatus of the first embodiment, and further includes a buffer management section 400 in the decoder control device 100, and an output control device 410 for taking in the output of the first frame memory 131 via a signal line 420 and the output of the second frame memory 132 via a signal line 421 to output an image via a signal line 423.

The buffer management section 400 takes in the amount of data supplied to the frame memories 131 and 132 corresponding to different bitstreams from the decoder 110 via a signal line 430, and takes in the amount of data consumed by the frame memories 131 and 132 corresponding to different bitstreams from the output control device 410 via a signal line 440.

The buffer management section 400 calculates the amount of data remaining in the frame memories 131 and 132 corresponding to different bitstreams based on the information taken in from the signal line 430 and the signal line 440. If the amount of data remaining is small, the buffer management section 400 instructs the decoder 110 via a signal line 431 to discontinue the decoding process, and instructs the output control device 410 via a signal line 441 to switch output images from one to another.

The decoder 110, upon receiving a decoding process discontinuation instruction from the buffer management section 400, discontinues the decoding process, and the output control device 410, upon receiving the output image switching instruction from the buffer management section 400, switches output images from one to another.

There is no particular limitation on the critical amount of data remaining in the frame memories 131 and 132 at which the buffer management section 400 gives the decoding process discontinuation instruction and the output image switching instruction.

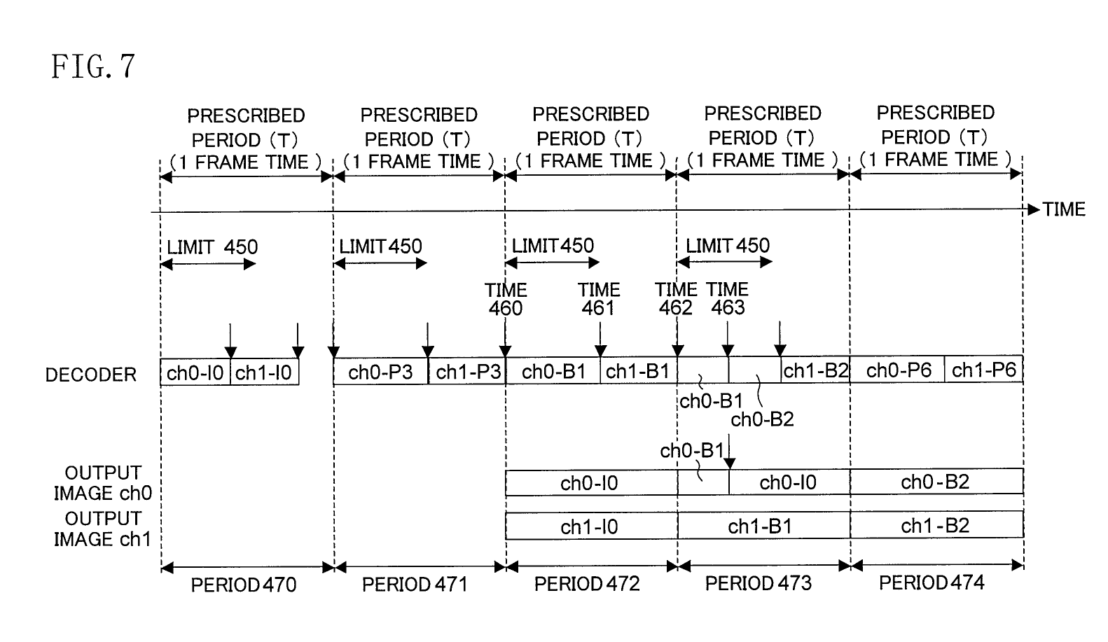

Next, an operation of a multi-stream decoder apparatus of the fourth embodiment will be described with reference to FIG. 7. Limit 450 in FIG. 7 denotes the limit time that is allowed for decoding the ch0 bitstream, and time 460 to 463 each denote a point in time at which bitstreams are switched from one to another or a predetermined unit of decoding process is completed. The designations I0, P3, B1, B2 and P6 in the decoder section denote the names of the pictures and the order they are output, wherein I0 is an I picture that is the first picture to be output, P3 is a P picture that is the fourth picture to be output, B1 is a B picture that is the second picture to be output, B2 is a B picture that is the third picture to be output, and P6 is a P picture that is the seventh picture to be output. For the sake of simplicity, the limit time allowed for completing the decoding of ch1 is the end of the prescribed period, which is not designated in the figure. While limit 450 takes the same value in all prescribed periods in the following description, the limit can be re-set for every prescribed period and the value thereof may vary.

An example of operation will be described, where only the decoding process is performed in period 470 and period 471, the image is output starting from period 472, the decoding process is discontinued in period 472, the discontinued decoding process is resumed in period 473, and the decoding process is discontinued and the output images are switched from one to another as instructed by the buffer management section 400 in period 473. The details of the control for the discontinuation and the resumption have been described above in the first embodiment, and will not be described repeatedly.

First, in period 470, I0 picture is decoded in the ch0 and ch1 bitstreams. Then, in period 471, P3 picture is decoded in the ch0 and ch1 bitstreams. It is assumed that the decoding process is not discontinued in period 470 and period 471.

Then, in period 472, B1 picture is decoded in the ch0 and ch1 bitstreams, and I0 picture of the ch0 bitstream and that of the ch1 bitstream are output.

At time 460, decoding of B1 picture in the ch0 bitstream is started. At time 461, the decoding of B1 picture of the ch0 bitstream is not completed until the limit time 450 for decoding ch0, thus discontinuing the ch0 decoding process and starting the decoding of B1 picture of the ch1 bitstream, which is completed at time 462.

Then, in period 473, B1 picture and B2 picture of the ch0 bitstream and B2 picture of the ch1 bitstream are decoded, and the output of B1 picture of the ch0 bitstream and that of the ch1 bitstream is started.

At time 462, the decoding of B1 picture of the ch0 bitstream is resumed, and at the same time, the output of B1 picture of the ch0 bitstream and that of the ch1 bitstream is started. Then, the decoding process of B1 picture of the ch0 bitstream and the output process occur simultaneously. At time 462, the amount of data of B1 picture supplied from the decoding process at the decoder 110 is greater than the amount of data of B1 picture consumed at the output control device 410. Therefore, in the beginning of period 473, B1 picture of ch0 is output.

At time 463, when the amount of data supplied from the decoder 110 becomes substantially equal to the amount of data consumed by the output control device 410, the buffer management section 400 instructs the decoder 110 to discontinue the decoding process of B1 picture of the ch0 bitstream, and instructs the output control device 410 to switch output images from one to another. The decoder 110, receiving the decoding process discontinuation instruction from the buffer management section 400, discontinues the decoding process of B1 picture to skip the picture and starts decoding B2 picture. The output control device 410, receiving the output image switching instruction from the buffer management section 400, switches the output image on the ch0 side from B1 picture to I0 picture whose decoding process has already been completed. While the amount of data supplied from the decoder 110 to the frame memory 131 becomes substantially equal to the amount of data consumed by the output control device 410 in this example, if there is some difference therebetween, the decoding process continues and the output images are not switched from one to another.

While the output image is switched to I0 picture, the picture to which the output image is switched is not limited to a particular picture.

Thus, according to the fourth embodiment, the decoding process can be performed while monitoring the data consumption by the output control device 410. Therefore, it is possible to continue the decoding process until the last moment before the output control device 410 completely consumes data.

Moreover, since the output images can be switched from one to another depending on the amount of data supplied from the decoder 110 and the amount of data consumed by the output control device 410, it is possible to output an image that does not give awkwardness even if the decoding process discontinues.

### FIFTH EMBODIMENT

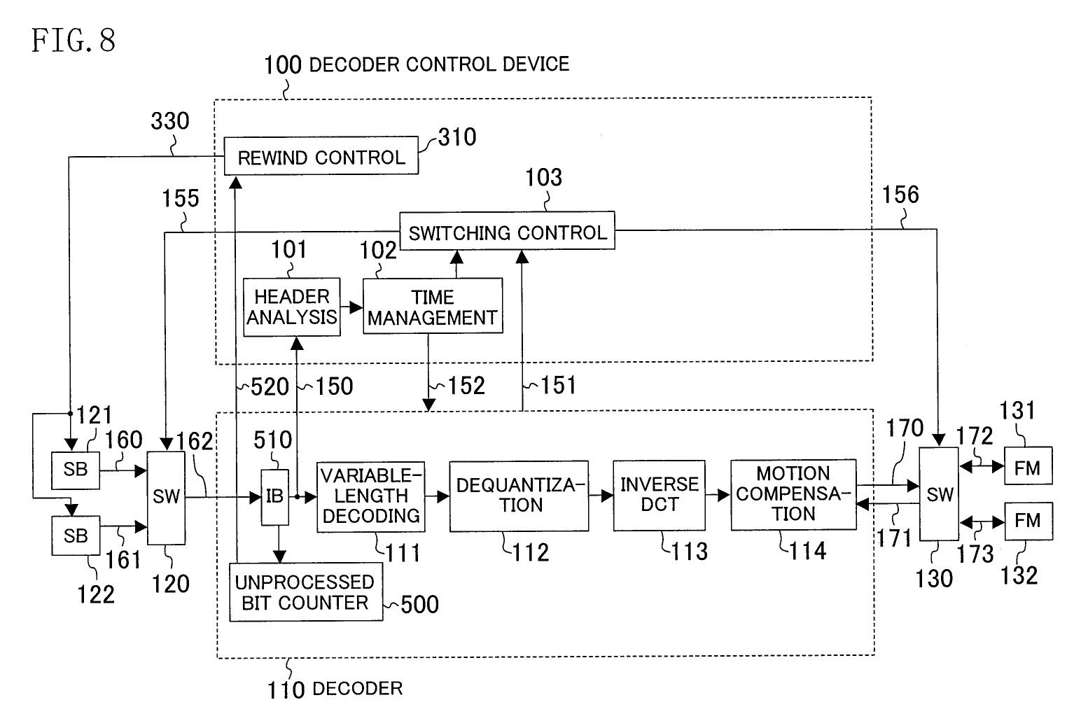

FIG. 8 shows a configuration of a multi-stream decoder apparatus according to a fifth embodiment. The multi-stream decoder apparatus of FIG. 8 includes the multi-stream decoder apparatus of the first embodiment, and further includes an unprocessed bit counter 500 and an input buffer (IB) 510 in the decoder 110, and the rewind control section 310 in the decoder control device 100.

The unprocessed bit counter 500 is a counter for monitoring the amount of bits of the bitstream in the input buffer 510 that have not been processed through the variable-length decoding section 111 of the decoder 110.

The rewind control section 310 has a function of taking in the value of the unprocessed bit counter 500 via a signal line 520, and rewinding the pointers of the first stream buffer 121 and the second stream buffer 122 for storing different bitstreams via a signal line 330.

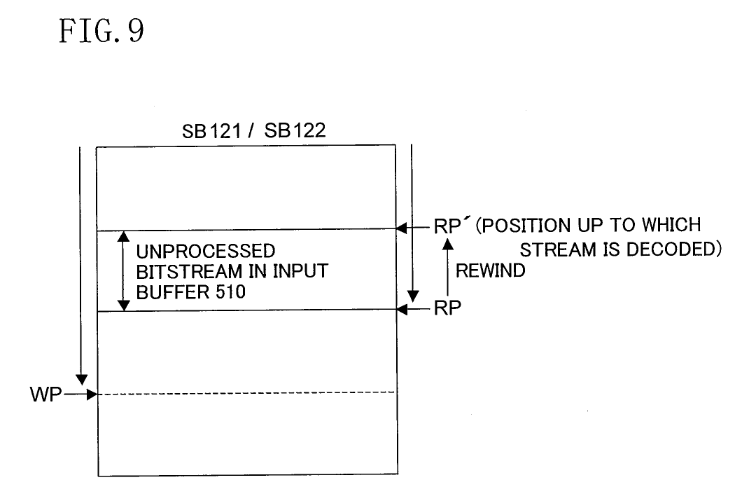

Next, an operation of the multi-stream decoder apparatus of the fifth embodiment will be described with reference to FIGS. 2 and 9. FIG. 9 shows the first stream buffer 121 and the second stream buffer 122, wherein WP is the pointer representing the status of the writing operation to the stream buffers 121 and 122 and RP is the pointer representing the status of the reading operation from the stream buffers 121 and 122. The rewind control section 310 rewinds RP back to RP′ using the value of the unprocessed bit counter 500.

How the unprocessed bit counter 500 and the rewind control section 310 are used will now be described based on the operation of period 210 in FIG. 2.

First, at time 220 when the decoding of one picture of the ch0 bitstream is completed, the decoder 110 sends a completion notification to the switching control section 103 in the decoder control device 100 via the signal line 151, the decoder control device 100 retracts the value of the unprocessed bit counter 500, and the switching control section 103 switches the bitstream to the ch1 bitstream.

At time 222, before the decoding of the ch0 bitstream is started, the rewind control section 310 rewinds the pointer of the first stream buffer 121 on the ch0 side by using the value of the unprocessed bit counter 500 retracted at time 220 to the position of the bitstream up to which the decoder 110 has actually processed the bitstream. While the control for ch1 is not described herein, the same operation is performed for ch1.

Thus, according to the fifth embodiment, it is possible to know the amount of bits consumed inside the decoder 110, whereby it is possible to eliminate the overhead of rewinding the bitstream when switching bitstreams from one to another.

### SIXTH EMBODIMENT

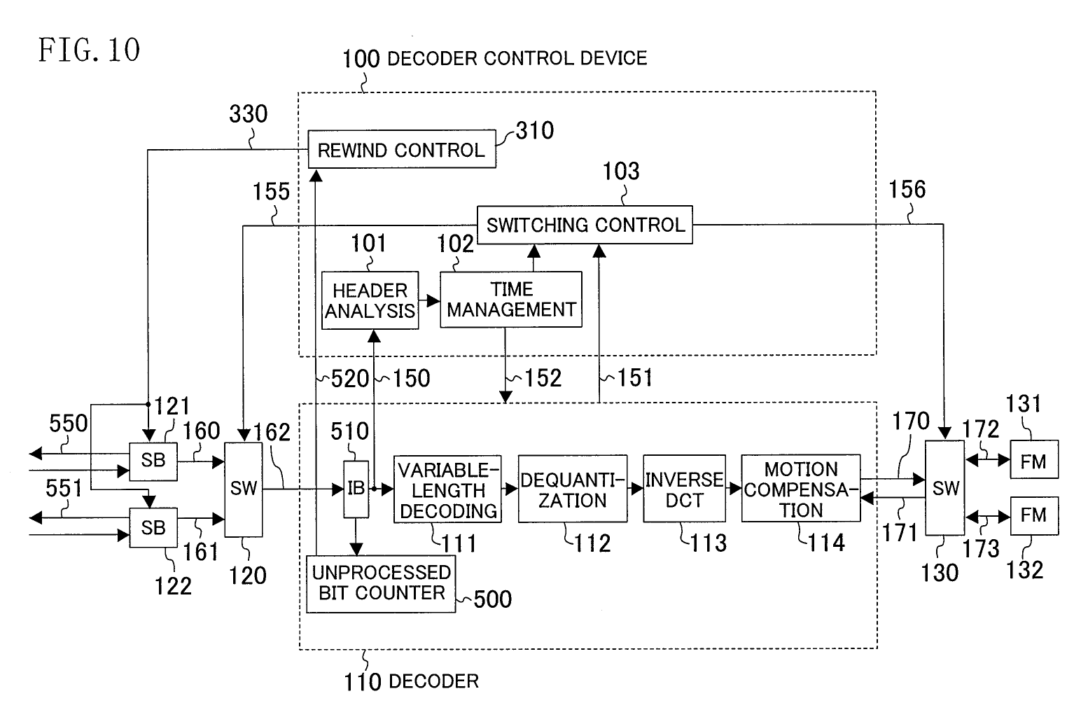

FIG. 10 shows a configuration of a multi-stream decoder apparatus according to a sixth embodiment. The multi-stream decoder apparatus of FIG. 10 includes the multi-stream decoder apparatus of the fifth embodiment, and the first and second stream buffers 121 and 122 have a function of preventing the overwriting of unprocessed bit data by using the information RP′ after the rewind as shown in FIG. 9.

Based on the RP′ information, the first stream buffer 121 and the second stream buffer 122 notify the bitstream supplying side of the stream buffer data writing limit value via a signal line 550 and a signal line 551, thereby preventing unprocessed data in the decoder 110 from being overwritten.

Thus, according to the sixth embodiment, it is possible to prevent an unprocessed bitstream in the decoder 110 from being overwritten.

### SEVENTH EMBODIMENT

A multi-stream decoder apparatus of a seventh embodiment includes the multi-stream decoder apparatus of the first embodiment, and further includes a mechanism wherein the switching control section 103 determines the order of bitstreams to be decoded based on the information on the bitstream, which was being decoded immediately before, at the start of the prescribed period. The apparatus configuration is as shown in FIG. 1.

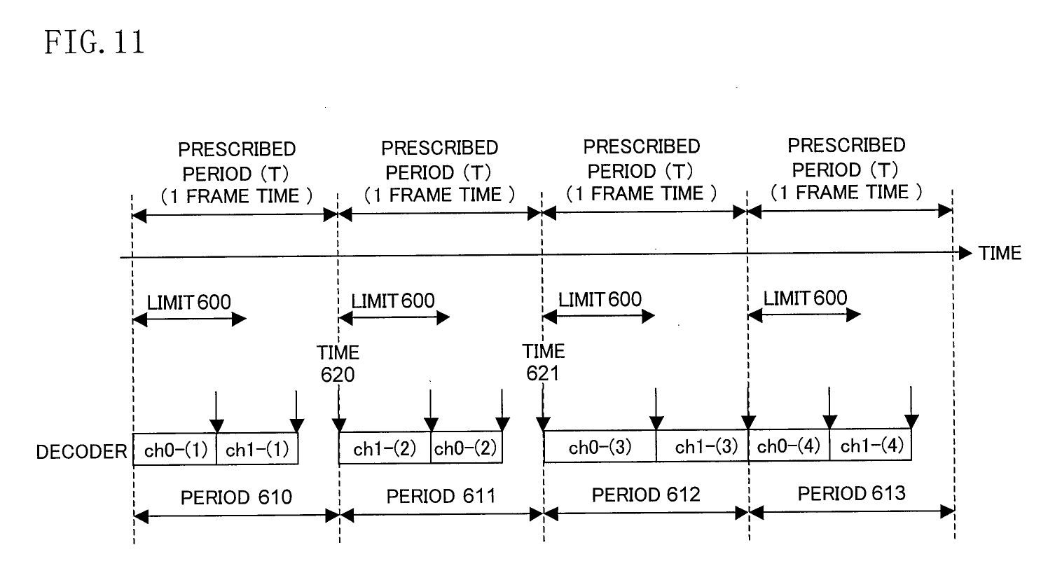

An operation of the multi-stream decoder apparatus of the seventh embodiment is shown in FIG. 11. The operation at time 620 and at time 621 will be described among all the points in time at which the prescribed period starts.

At time 620, since the bitstreams were decoded in the order of ch0 and ch1 in prescribed period 610, the switching control section 103 determines that ch1 was being decoded immediately before the start of prescribed period 611, and the bitstreams are not switched from one to another, whereby the bitstreams are decoded in the order of ch1 and ch0 in prescribed period 611. Similarly, at time 621, the switching control section 103 determines that ch0 was being decoded immediately before the start of prescribed period 612, and the bitstreams are not switched from one to another, whereby the bitstreams are decoded in the order of ch0 and ch1 in prescribed period 612. This similarly applies even if the bitstream decoding process is discontinued and resumed within the prescribed time, whereby the order in which the bitstreams are processed becomes irregular.

Thus, according to the seventh embodiment, it is possible to reduce the overhead due to bitstream switching.

### EIGHTH EMBODIMENT

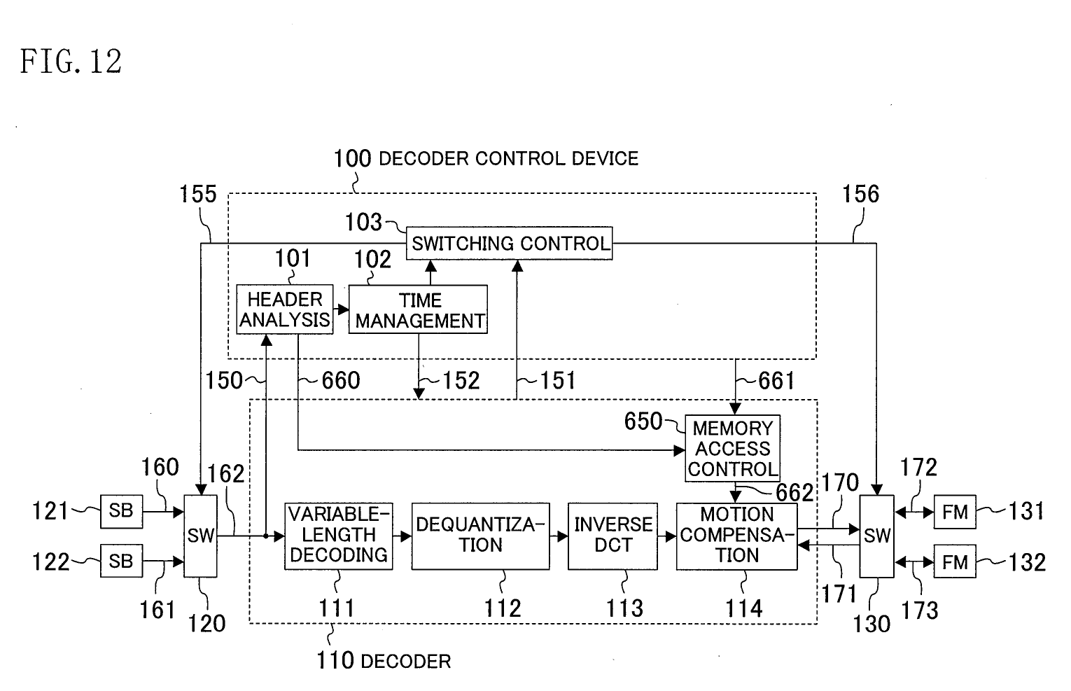

FIG. 12 shows a configuration of a multi-stream decoder apparatus according to an eighth embodiment. The multi-stream decoder apparatus of FIG. 12 includes the multi-stream decoder apparatus of the first embodiment, and further includes a memory access control section 650 in the decoder 110.

The memory access control section 650 obtains via a signal line 660 the image size information and the frame rate information, which have been obtained by the header analysis section 101, and obtains from the decoder control device 100 via a signal line 661 information such as the number of bitstreams to be decoded, based on which the memory access control section 650 determines the memory access rate that is necessary for the decoder 110 to complete the decoding process within the prescribed period.

How to determine the memory access rate will now be described with the following examples.

(i) HD (High Definition) 2ch decoding
ch0 Image size: 1920 pixels×1088 lines
ch1 Image size: 1920 pixels×1088 lines
   (ii) HD 1ch decoding
ch0 Image size: 1920 pixels×1088 lines
ch1 No decoding process
   (iii) SD (Standard Definition) 2ch decoding
ch0 Image size: 720 pixels×480 lines
ch1 Image size: 720 pixels×480 lines

The memory access control section 650 obtains the information from the decoder control device 100 to judge the memory access rate that is necessary for completing the decoding process within the prescribed period, thus determining the memory access rate. Herein, the necessary memory access rate is determined based on the image size. For the sake of simplicity, the memory access rate for Example (i) is assumed to be A accesses/hour as the reference rate, and the frame rate is assumed to be the same.

For (i) HD 2ch decoding (reference), since the memory access rate that is necessary for completing the decoding process within the prescribed period is A accesses/hour, the memory access control section 650 sets the memory access rate to A accesses/hour.

For (ii) HD 1ch decoding, the memory access rate that is necessary for completing the decoding process within the prescribed period is ½ that for HD 2ch decoding, based on the image size information. The memory access control section 650 sets the memory access rate to (½) A accesses/hour.

For (iii) SD 2ch decoding, the memory access rate that is necessary for completing the decoding process within the prescribed period is (720×480)/(1920×1088)=about ⅙ that for HD 2ch decoding, based on the image size information. The memory access control section 650 sets the memory access rate to about (⅙) A accesses/hour.

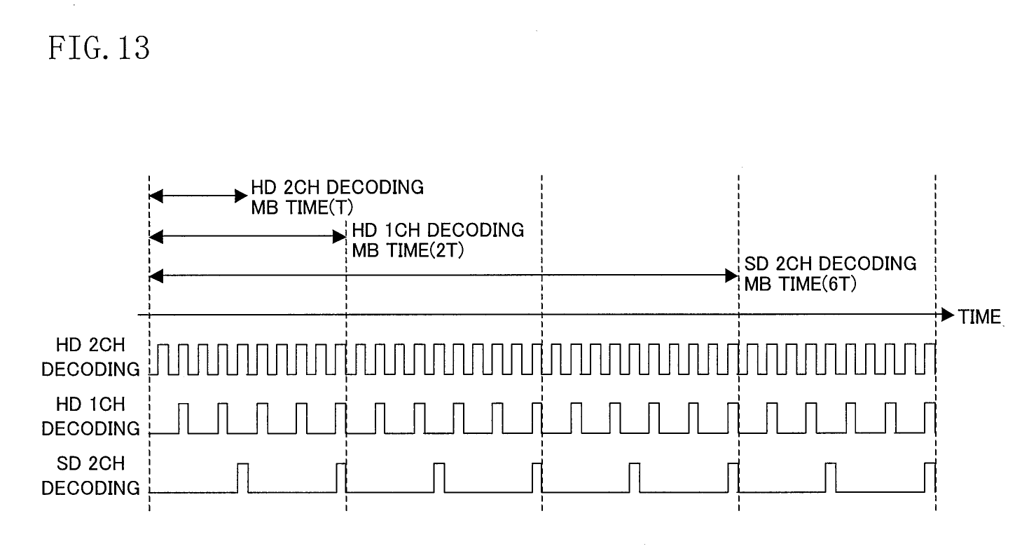

Based on a value calculated as described above, the memory access control section 650 controls the memory access rate. FIG. 13 shows the memory access frequency for Examples (i), (ii) and (iii) above. Where the memory access rate is not controlled by the memory access control section 650, the same peak memory bandwidth as that for Example (i) is used for all Examples (i), (ii) and (iii). If the rate is controlled, however, the peak memory bandwidth can be suppressed to a level according to each of (i), (ii) and (iii).

Thus, according to the eighth embodiment, the memory bandwidth can be suppressed to the peak memory bandwidth according to the bitstream to be decoded, whereby it is possible to give some memory bandwidth to other applications in a system where external memory is shared.

### NINTH EMBODIMENT

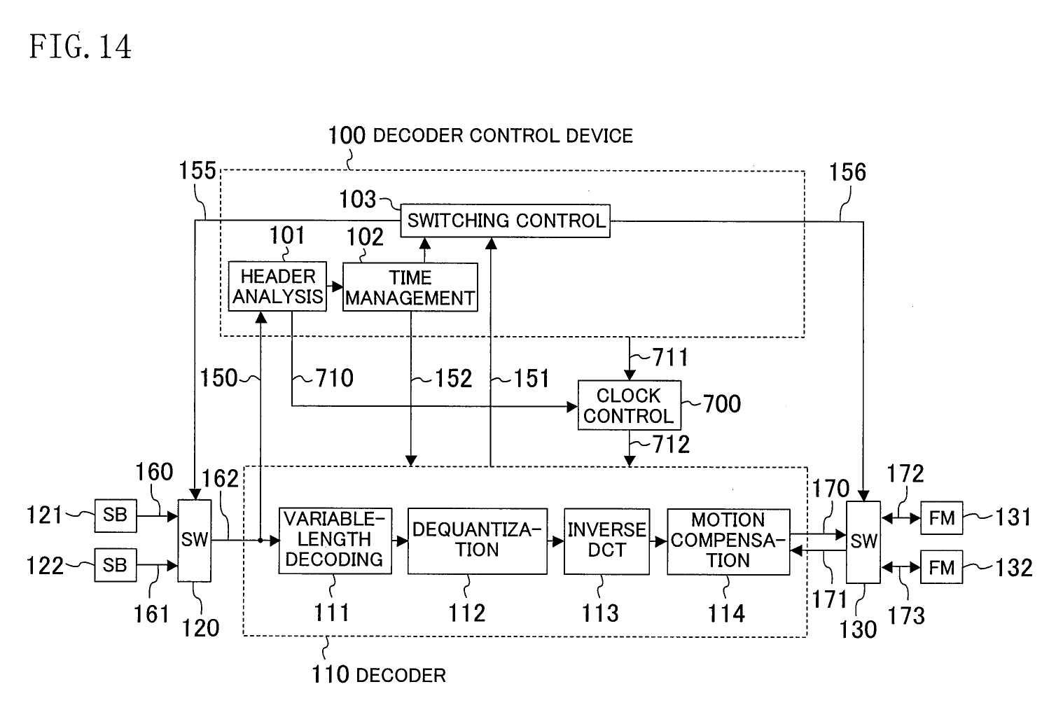

FIG. 14 shows a configuration of a multi-stream decoder apparatus according to a ninth embodiment. The multi-stream decoder apparatus of FIG. 14 includes the multi-stream decoder apparatus of the first embodiment, and further includes a clock control section 700.

The clock control section 700 obtains via a signal line 710 the image size information and the frame rate information, which have been obtained by the header analysis section 101, and obtains from the decoder control device 100 via a signal line 711 information such as the number of bitstreams to be decoded, based on which the clock control section 700 supplies via a signal line 712 the clock that is necessary for the decoder 110 to complete the decoding process within the prescribed period.

The clock control section 700 obtains the information from the decoder control device 100 to judge the clock frequency that is necessary for completing the decoding process within the prescribed period, thus controlling the clock frequency. Herein, the necessary clock frequency is determined based on the image size. For the sake of simplicity, the clock frequency for Example (i) is assumed to be S megahertz (MHz) as the reference, and the frame rate is assumed to be the same.

The clock is controlled as follows for Examples (i), (ii) and (iii).

For (i) HD 2ch decoding (reference), since the clock frequency that is necessary for completing the decoding process within the prescribed period is S MHz, the clock control section 700 sets the clock frequency to S MHz.

For (ii) HD 1ch decoding, the clock frequency that is necessary for completing the decoding process within the prescribed period is ½ that for HD 2ch decoding, based on the image size information. The clock control section 700 sets the clock frequency to (½) S MHz.

For (iii) SD 2ch decoding, the clock frequency that is necessary for completing the decoding process within the prescribed period is (720×480)/(1920×1088)=about ⅙ that for HD 2ch decoding, based on the image size information. The clock control section 700 sets the clock frequency to about (⅙) S MHz.

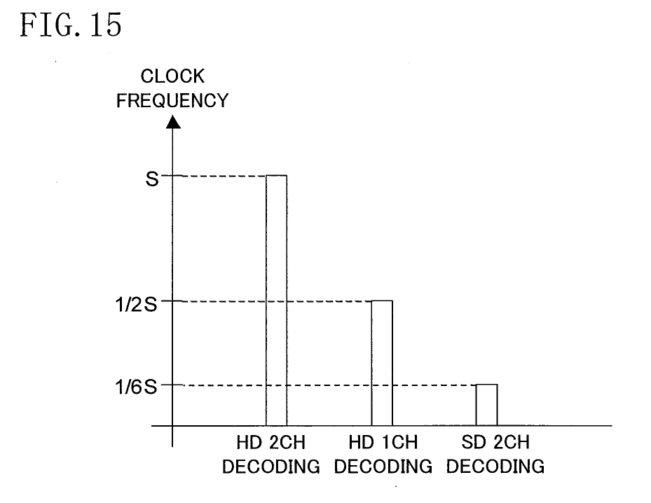

Based on a value calculated as described above, the clock control section 700 controls the clock frequency. FIG. 15 shows Examples (i), (ii) and (iii). Where the clock frequency is not controlled by the clock control section 700, the clock frequency will be the same for all of (i), (ii) and (iii), thus resulting in the same amount of power consumed. If the clock frequency is controlled, however, the clock frequency can be set to a value suitable for each of (i), (ii) and (iii), whereby it is possible to suppress the power consumption to a level according to each of (i), (ii) and (iii).

Thus, according to the ninth embodiment, the clock frequency can be set to a value according to the bitstream to be decoded, whereby it is possible to suppress the power consumption.

### TENTH EMBODIMENT

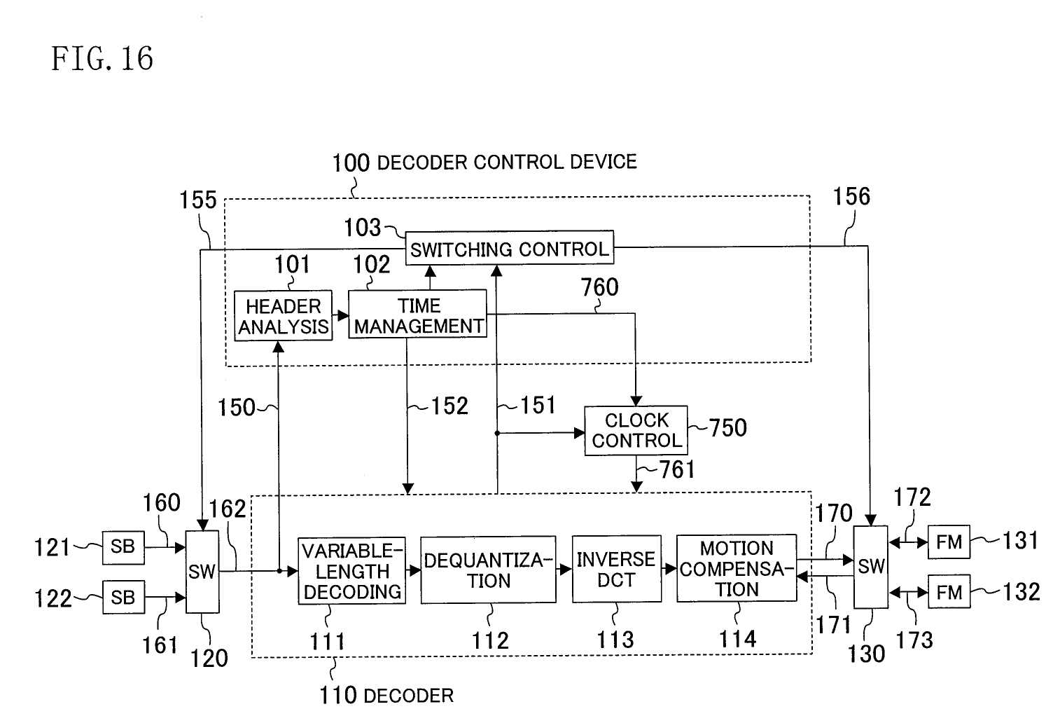

FIG. 16 shows a configuration of a multi-stream decoder apparatus according to a tenth embodiment. The multi-stream decoder apparatus of FIG. 16 includes the multi-stream decoder apparatus of the first embodiment, and further includes a clock control section 750.

The clock control section 750 obtains prescribed time information from the time management section 102 via a signal line 760, and receives a completion notification from the decoder 110 every picture, based on which the clock control section 750 determines whether or not the clock needs to be supplied to the decoder 110 to selectively supply or stop the clock to the decoder 110 via a signal line 761.

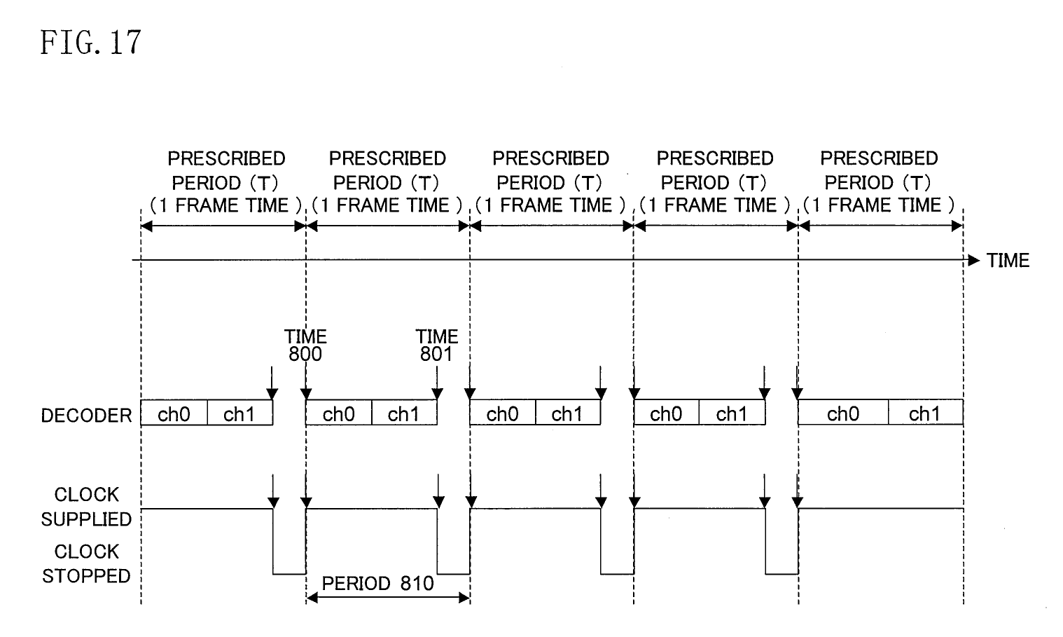

Next, an operation of a multi-stream decoder apparatus of the tenth embodiment will be described with reference to FIG. 17. The operation of period 810 will now be described with respect to how the clock is supplied and stopped.

In period 810, the clock control section 750 starts the clock supply to the decoder 110 at time 800. When the decoding of the ch0 bitstream and that of the ch1 bitstream are completed at time 801, it is no longer necessary to operate the decoder 110 within the prescribed period. Therefore, the clock control section 750 stops the clock supply to the decoder 110. The clock control section 750 repeats this control for every prescribed period.

Thus, the clock control section 750 supplies the clock only when the decoder 110 needs to be operated, whereby it is possible to suppress the power consumption.

Thus, according to the tenth embodiment, where decoding of a plurality of bitstreams is completed before the end of the prescribed time, the clock can be stopped, thus suppressing the power consumption.

### INDUSTRIAL APPLICABILITY

The multi-stream decoder apparatus of the present invention is applicable to decoder apparatuses for use with storage media such as digital TVs, DVDs, DVRs, etc.

1. A multi-stream decoder apparatus, comprising storage devices each storing one of a plurality of bitstreams, a first switching device for switching between outputs from the storage devices, a decoder for receiving and decoding an output from the first switching device, a plurality of frame memories for storing data decoded by the decoder, a second switching device for switching between the frame memories depending on the bitstream, and a decoder control means for controlling the decoder, wherein:
the decoder control means includes:
header analysis means for analyzing a header in the bitstream;
time management means for allotting a process time to each bitstream; and
switching control means for controlling the first and second switching devices;
the time management means determines a limit time that is allowed for decoding each bitstream within a prescribed time based on bitstream information including an image size and a frame rate obtained by the header analysis means, a processing capacity of the decoder, and information including the number of bitstreams to be decoded, and outputs a bitstream switching instruction signal when the decoding process reaches the limit time; and
the switching control means switches the first and second switching devices based on the bitstream switching instruction signal output from the time management means, and a completion notification signal, which is output when the decoder completes decoding of a first predetermined unit of each bitstream.

2. The multi-stream decoder apparatus of claim 1, wherein the time management means re-sets the limit time that is allowed for decoding each bitstream for each prescribed time.

3. The multi-stream decoder apparatus of claim 1, wherein the time management means instructs the decoder to discontinue the decoding process when bitstream decoding process time reaches the limit time, and the decoder immediately discontinues the decoding process upon receiving the discontinuation instruction.

4. The multi-stream decoder apparatus of claim 3, wherein when decoding is discontinued, the decoder control means retracts information in the decoder that is necessary for resuming the discontinued decoding process, and resumes the decoding process by re-setting the retracted information in the decoder before the discontinued bitstream decoding process is next started.

5. The multi-stream decoder apparatus of claim 4, wherein decoding processes of a plurality of bitstreams are discontinued within the prescribed time and if decoding of the first predetermined unit of a bitstream other than the discontinued bitstreams is completed early to leave spare process time within the prescribed time, the limit time that is allowed for decoding each discontinued bitstream is re-set based on an estimated time required for completing decoding of the first predetermined unit of the bitstream.

6. The multi-stream decoder apparatus of claim 4, wherein:
the apparatus comprises a first counter in the decoder for counting an amount of bits processed starting from a beginning of a second predetermined unit, and rewind control means in the decoder control means for rewinding a pointer of the storage device; and
when the decoder control means resumes the decoding process on a bitstream of which the decoding process has been discontinued by the time management means, the rewind control means rewinds the pointer of the storage device back to a beginning of the second predetermined unit based on information of the first counter so that the decoding process is resumed starting from the beginning of the second predetermined unit.

7. The multi-stream decoder apparatus of claim 4, wherein:
the apparatus further comprises an output control device for receiving outputs from the plurality of frame memories to output an image, and buffer management means in the decoder control means for managing an amount of data of the plurality of frame memories; and
based on an amount of data supplied to the plurality of frame memories, which is notified from the decoder and an amount of data consumed by the plurality of frame memories, which is notified from the output control device, the buffer management means instructs the decoder to discontinue the decoding process, and the decoder immediately discontinues the decoding process upon receiving the discontinuation instruction.

8. The multi-stream decoder apparatus of claim 7, wherein based on an amount of data supplied to the plurality of frame memories, which is notified from the decoder and an amount of data consumed by the plurality of frame memories, which is notified from the output control device, the buffer management means instructs the output control device to switch output images from one to another, and the output control device immediately switches the output images from one to another upon receiving the switching instruction.

9. The multi-stream decoder apparatus of claim 1, wherein:
the apparatus comprises in the decoder an input buffer for temporarily holding an output from the first switching device and a second counter for monitoring an amount of unprocessed bits in the input buffer, and comprises in the decoder control means rewind control means for rewinding a pointer of the storage device;
the decoder control means retracts information of the second counter when the switching control means switches the first switching device; and
when resuming the decoding process on the bitstream, which was being processed before the switching, the rewind control means rewinds the pointer of the storage device to a position up to which the decoder has actually consumed the bitstream based on the information of the second counter.

10. The multi-stream decoder apparatus of claim 9, further comprising means for preventing the bitstream in the storage device from being overwritten based on information on the pointer of the storage device.

11. The multi-stream decoder apparatus of claim 1, wherein the decoder control means judges, for each prescribed time, a type of the bitstream, which was being decoded by the decoder until immediately before an end of the prescribed time, to determine an order in which bitstreams are decoded in the next prescribed time.

12. The multi-stream decoder apparatus of claim 1, wherein:
the apparatus comprises in the decoder a memory access control device for controlling a frequency of access to the plurality of frame memories; and
the memory access control device controls the frequency of access to the plurality of frame memories based on bitstream information including an image size and a frame rate obtained by the header analysis means and information including the number of bitstreams to be decoded, which is notified from the decoder control means.

13. The multi-stream decoder apparatus of claim 1, further comprising a clock control device for determining a frequency of a clock supplied to the decoder based on bitstream information including an image size and a frame rate obtained by the header analysis means, a processing capacity of the decoder, and information including the number of bitstreams to be decoded, which is notified from the decoding control means.

14. The multi-stream decoder apparatus of claim 1, further comprising a clock control device for selectively supplying or stopping a clock to the decoder based on information on the prescribed time notified from the decoder control means and completion notification from the decoder notifying completion of the first predetermined unit of decoding process.

15. The multi-stream decoder apparatus of claim 1, wherein the first predetermined unit is pictures, slices, macroblock lines, or macroblocks.

16. The multi-stream decoder apparatus of claim 1, wherein the prescribed time is a picture time, a slice time, a macroblock line time or a macroblock time averagely allotted based on a frame rate in the bitstream.

17. The multi-stream decoder apparatus of claim 6, wherein the second predetermined unit is pictures, slices, macroblock lines, or macroblocks.

18. The multi-stream decoder apparatus of claim 1, wherein the bitstream is a bitstream compressed in MPEG1, MPEG2, MPEG4, or H.264.
